(19) United States
(12) Patent Application Publication
(10) Pub. No.: US 2026/0142107 A1
(43) Pub. Date: May 21, 2026

(54) BLOCKING DEVICE

(71) Applicant: Panasonic Intellectual Property Management Co., Ltd., Osaka (JP)

(72) Inventors: SHUN ITO, Hyogo (JP); SHINYA KIMOTO, Osaka (JP); KOHEI SHIBUSE, Osaka (JP); MASATO NAKAMURA, Hyogo (JP); YOICHIRO MORIYAMA, Osaka (JP)

(21) Appl. No.: 19/128,583

(22) PCT Filed: Aug. 23, 2023
(86) PCT No.: PCT/JP2023/030349

§ 371 Date: May 9, 2025

(30) Foreign Application Priority Data
Dec. 23, 2022 (JP) 2022-207297

(51) Int. Cl. H01H 39/00

(52) U.S. Cl. CPC H01H 39/006

(57) ABSTRACT

This breaker device includes: a casing; a pusher located inside the casing and including a recessed portion; an igniter storing gunpowder, including a lid portion between the gunpowder and the pusher, being disposed in the recessed portion, and being configured to generate gas; a protective portion provided to the casing or the igniter and located inside the recessed portion; and a conductor including a separating portion located below the pusher. When the pusher receives pressure of the gas generated by the igniter, the pusher moves the separating portion downward. The lid portion includes an opening portion configured to open by receiving the pressure of the gas. The lower end of the protective portion is located at a level below the lower end of the lid portion.

### TECHNICAL FIELD

The present disclosure relates to breaker devices.

### BACKGROUND ART

There are conventionally known breaker devices that, when in use, are connected to an electrical circuit. Among the breaker devices, a breaker device has been disclosed that includes: a piston (pusher) including a recess; an igniter disposed in the recess; and a busbar (conductor), and is configured so that the piston moves from a raised position to a lowered position to cut a part of the busbar (refer to Patent Literature (PTL) 1).

### CITATION LIST

### Patent Literature

PTL 1: Unexamined Japanese Patent Publication (Japanese Translation of PCT Publication) No. 2017-533570

### SUMMARY OF INVENTION

### Technical Problem

It is however assumed that the piston disclosed in PTL 1 has reduced strength due to the recessed part being thin. Therefore, there is a risk that the pusher may be damaged when the igniter generates gas, for example.

In view of the foregoing, the present disclosure provides a breaker device capable of reducing the occurrence of damage to a pusher when an igniter generates gas.

A breaker device according to one aspect of the present disclosure incudes: a casing; a pusher located inside the casing and including a recessed portion; an igniter storing gunpowder, including a lid portion between the gunpowder and the pusher, being disposed in the recessed portion, and being configured to generate gas; a protective portion disposed on the casing or the igniter and located inside the recessed portion; and a conductor including a separating portion located below the pusher. When the pusher receives pressure of the gas generated by the igniter, the pusher moves the separating portion downward. The lid portion includes an opening portion configured to open by receiving the pressure of the gas. A lower end of the protective portion is located at a level below a lower end of the lid portion.

A breaker device according to one aspect of the present disclosure incudes: a casing; a pusher located inside the casing and including a recessed portion; an igniter storing gunpowder, including a lid portion between the gunpowder and the pusher, being disposed in the recessed portion, and being configured to generate gas; a protective portion provided to cover an inner surface of the recessed portion; and a conductor including a separating portion located below the pusher. When the pusher receives pressure of the gas generated by the igniter, the pusher moves the separating portion downward.

According to one aspect of the present disclosure, it is possible to realize a breaker device capable of reducing the occurrence of damage to a pusher when an igniter generates gas.

### BRIEF DESCRIPTION OF DRAWINGS

FIG. 1A is a first perspective view illustrating a breaker device according to Embodiment 1.

FIG. 1B is a second perspective view illustrating a breaker device according to Embodiment 1.

FIG. 2 is a cross-sectional perspective view illustrating a breaker device according to Embodiment 1.

FIG. 3A is a cross-sectional view illustrating a breaker device according to Embodiment 1.

FIG. 3B is a perspective view illustrating a part of an igniter according to Embodiment 1 that has not generated gas yet.

FIG. 3C is a plan view of a lid portion of an igniter and a protective portion according to Embodiment 1 in the state where the igniter has not generated gas yet.

FIG. 4A is a cross-sectional view for describing an interrupting operation of a breaker device according to Embodiment 1.

FIG. 4B is a perspective view illustrating a part of an igniter according to Embodiment 1 that has generated gas.

FIG. 5A is a cross-sectional view illustrating a breaker device according to Variation 1 of Embodiment1.

FIG. 5C is a cross-sectional view illustrating a breaker device according to Variation 3 of Embodiment 1.

FIG. 5D is a cross-sectional view illustrating a breaker device according to Variation 4 of Embodiment 1.

FIG. 6 is a flowchart illustrating a manufacturing process of a breaker device according to Embodiment 1.

FIG. 7 is a cross-sectional view illustrating a breaker device according to Embodiment 2.

FIG. 8 is a cross-sectional view illustrating a breaker device according to another exemplary embodiment.

FIG. 9 is a cross-sectional view for describing a situation in which a separating portion in a breaker device according to another exemplary embodiment has moved downward.

### DESCRIPTION OF EMBODIMENTS

A breaker device according to one aspect of the present disclosure incudes: a casing; a pusher located inside the casing and including a recessed portion; an igniter storing gunpowder, including a lid portion between the gunpowder and the pusher, being disposed in the recessed portion, and being configured to generate gas; a protective portion provided to the casing or the igniter and located inside the recessed portion; and a conductor including a separating portion located below the pusher. When the pusher receives pressure of the gas generated by the igniter, the pusher moves the separating portion downward. The lid portion includes an opening portion configured to open by receiving the pressure of the gas. A lower end of the protective portion is located at a level below a lower end of the lid portion.

Thus, since the lower end of the protective portion is located at a level below the lower end of the lid portion, when the opening portion opens downward by receiving the pressure of the gas generated by the igniter, the opening portion that is open comes into contact with the protective portion and is restricted by the protective portion from opening wide. In other words, the protective portion serves as a barrier that prevents the opening portion from opening wide and can keep the opening portion that is open from coming into contact with the recessed portion of the pusher. Thus, the breaker device can reduce the occurrence of damage to the pusher that is due to contact of the opening portion when the igniter generates gas.

Furthermore, for example, it is preferable that the protective portion include: a first cylindrical portion connected to the casing; and a second cylindrical portion located at a level below the first cylindrical portion and having a diameter less than a diameter of the first cylindrical portion.

Thus, since the second cylindrical portion of the protective portion is located inward of the first cylindrical portion thereof, the thickness of the recessed part of the pusher that corresponds to the second cylindrical portion can be made greater than that expected when the first cylindrical portion and the second cylindrical portion have the same diameter. This means that it is possible to improve the strength of the pusher. Thus, the breaker device can further reduce the occurrence of damage to the pusher.

Furthermore, for example, it is preferable that the recessed portion of the pusher include: a first section having a diameter greater than the diameter of the first cylindrical portion; and a second section located at a level below the first section and having a diameter greater than the diameter of the second cylindrical portion, and the diameter of the first section be greater than the diameter of the second section.

Thus, since the thickness of the second section of the recessed portion can be made great, it is possible to improve the strength of the pusher as compared to when the thickness of the second section is equal to the thickness of the first section. Thus, the breaker device can further reduce the occurrence of damage to the pusher.

Furthermore, for example, it is preferable that a distance between the lower end of the lid portion and a lower end of the second cylindrical portion be greater than or equal to half of a length of a cutout in the opening portion of the lid portion.

Thus, since the second cylindrical portion extends to a position that is lower in level by at least half of the length of a surface of the lid portion, it is possible to more reliably keep the opening portion from coming into contact with the pusher. Accordingly, the breaker device can more reliably reduce the occurrence of damage to the pusher.

Furthermore, for example, it is preferable that a diameter of a lower opening of the protective portion be less than a diameter of the lid portion.

Thus, the pressure of the gas generated by the igniter can be concentrated and therefore, the amount of gunpowder can be reduced.

Furthermore, for example, it is preferable that the casing be made from a metal, the protective portion include: a metal member connected to the casing; and a resin member disposed inward of the metal member, the metal member include the first cylindrical portion and the second cylindrical portion, and a vertical length from an upper end of the resin member to a lower end of the resin member be greater than a vertical length from the lower end of the lid portion to a lower end of the second cylindrical portion.

Thus, since the opening portion and the resin member come into contact when the igniter generates gas, it is possible to reduce the occurrence of electrical conduction between the opening portion and the casing via the metal member even when the opening portion is formed of a metal. Specifically, the resin member can block the electric arc generated during interruption from reaching the igniter via the casing.

Furthermore, for example, it is preferable that the resin member include: a first portion disposed inward of the metal member; a second portion disposed outward of the metal member; and a third portion connecting the first portion and the second portion, and the third portion be located at a level below the metal member.

Thus, since the third portion is located at a level below the metal member, it is possible to more reliably keep the opening portion and the metal member from coming into contact after the igniter generates gas.

Furthermore, for example, the protective portion may include a resin portion and a metal portion, the resin portion and the metal portion may be integrally formed, and the resin portion may cover an area of an inner surface of the metal portion that is located at a level below the lid portion.

Thus, as compared to when the resin portion and the metal portion are separate bodies, a manufacturing process such as attaching the resin portion to the metal portion can be omitted and therefore, the manufacture can be facilitated.

Furthermore, for example, it is preferable that a distance between the lower end of the lid portion and a lower end of the resin portion be greater than or equal to half of a length of a cutout in the opening portion of the lid portion.

Thus, since the resin portion extends to a position that is lower in level by at least half of the length of a surface of the lid portion, it is possible to more reliably reduce the occurrence of electrical conduction between the opening portion and the casing via the metal portion after the igniter generates gas.

Furthermore, for example, it is preferable that the resin portion include: a first portion disposed inward of the metal portion; a second portion disposed outward of the metal portion; and a third portion connecting the first portion and the second portion, and the third portion be located at a level below the metal portion.

Thus, since the third portion is located at a level below the metal portion, it is possible to more reliably keep the opening portion and the metal portion from coming into contact after the igniter generates gas.

Furthermore, a breaker device according to one aspect of the present disclosure incudes: a casing; a pusher located inside the casing and including a recessed portion; an igniter storing gunpowder, including a lid portion between the gunpowder and the pusher, being disposed in the recessed portion, and being configured to generate gas; a protective portion provided to cover an inner surface of the recessed portion; and a conductor including a separating portion located below the pusher. When the pusher receives pressure of the gas generated by the igniter, the pusher moves the separating portion downward.

Thus, since the recessed portion of the pusher is covered by the protective portion, when the opening portion opens downward by receiving the pressure of the gas generated by the igniter, the opening portion that is open contacts the protective portion and is restricted by the protective portion from coming into contact with the recessed portion of the pusher. Thus, the breaker device can reduce the occurrence of damage to the pusher that is due to contact of the opening portion when the igniter generates gas.

Furthermore, for example, it is preferable that the protective portion cover an area of the inner surface of the recessed portion that is located at a level below the lid portion.

Thus, since the protective portion covers a part of the pusher that the opening portion may touch, it is possible to effectively reduce damage to the pusher.

Furthermore, for example, it is preferable that the protective portion be a metal layer covering the inner surface of the recessed portion or an insulating layer covering the inner surface of the recessed portion and made from a material different from a material of the pusher, and the protective portion be located between the lid portion and the pusher.

Thus, it is possible to reduce damage to the pusher by the metal layer or the insulating layer formed integrally with the pusher. Furthermore, for example, when the protective portion is a metal layer, it is further possible to more reliably reduce damage to the pusher, and when the protective portion is an insulating layer, it is further possible to reduce the occurrence of electrical conduction between the opening portion and the casing via the protective portion.

Furthermore, for example, it is preferable that the protective portion be a metal member or an insulating member disposed inside the recessed portion, and the metal member or the insulating member be located between the lid portion and the pusher.

Thus, it is possible to reduce damage to the pusher by the metal member or the insulating member that is separate from the pusher. Furthermore, for example, when the protective portion is a metal member, it is further possible to more reliably reduce damage to the pusher, and when the protective portion is an insulating member, it is further possible to reduce the occurrence of electrical conduction between the opening portion and the casing via the protective portion.

Furthermore, for example, it is preferable that the protective portion completely cover the inner surface of the recessed portion that is located at a level below the lid portion.

Thus, since the protective portion completely (including substantially completely) covers a part of the pusher that the opening portion may touch, it is possible to more effectively reduce damage to the pusher.

Furthermore, for example, the protective portion may be configured to come into contact with the lid portion when the gas is generated.

Thus, the protective portion can keep the lid portion from coming into contact with the pusher and therefore, it is possible to reduce the occurrence of damage to the pusher.

Note that when the pusher receives the pressure of the gas generated by the igniter, the pusher may cut off the separating portion from the conductor and move the separating portion downward.

Hereinafter, exemplary embodiments, etc., will be specifically described with reference to the drawings.

Note that each of the exemplary embodiments, etc., described below shows a general or specific example. The numerical values, shapes, structural elements, the arrangement and connection of the structural elements, steps (manufacturing steps), the processing order of the steps (manufacturing steps), etc., shown in the following exemplary embodiments, etc., are mere examples, and are not intended to limit the present disclosure. Among the structural elements in the following exemplary embodiments, structural elements not recited in any one of the independent claims are described as optional structural elements.

Note that the figures are schematic diagrams and are not necessarily precise illustrations. Therefore, for example, scale reduction and the like in the figures are not necessarily the same. Furthermore, in the figures, substantially identical elements are assigned the same reference signs, and overlapping description will be omitted or simplified.

In the present specification and the drawings, the X-axis, the Y-axis, and the Z-axis represent three axes of the right-handed three-dimensional Cartesian coordinate system. In each of the exemplary embodiments, etc., the Z-axis direction is a direction of movement of the pusher. In the present specification, the phrase “in plan view” indicates viewing the breaker device in the Z-axis direction, and the term “lateral/side” indicates a direction perpendicular to the Z-axis direction. Furthermore, in the present specification, the Z-axis direction is also referred to as the up-down or vertical direction. Note that the up-down or vertical direction of the breaker device in the present specification merely indicates relative positioning of elements included in the breaker device for the sake of description of each of the exemplary embodiments, etc. For example, in the present specification, the terms “up/upward/above/top” and “down/downward/below/bottom” do not indicate an upward direction (vertically upward) and a downward direction (vertically downward) in a sense of absolute space, but are used as terms defined by relative positioning on the basis of the direction of movement of the pusher. The posture of the breaker device when installed is not limited by the directions illustrated in the drawings.

Furthermore, in the present specification, terms indicating the relationship between elements such as being equal and being parallel, terms indicating the shapes of elements such as a circle and a trapezoid, numerical values, and numerical ranges are not expressions referring to only exact meanings, but are expressions referring to substantially equivalent ranges including, for example, approximately a few percent (for example, approximately 10%) differences.

Furthermore, in the present specification, ordinal numbers such as “first” and “second” do not indicate the number of structural elements or the sequence of structural elements, but are used for the purpose of avoiding confusion and distinguishing between structural elements of the same kind, unless otherwise noted.

### Embodiment 1

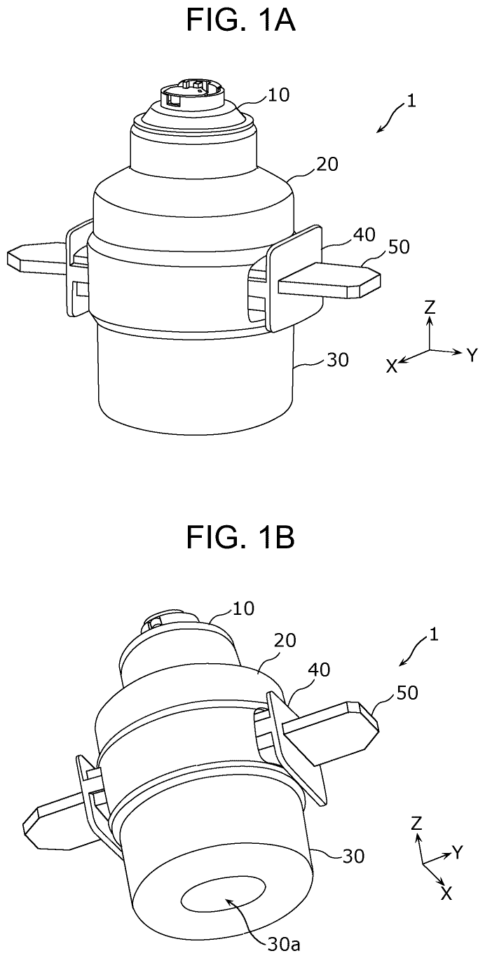

Hereinafter, the breaker device according to the present exemplary embodiment will be described with reference to FIG. 1A to FIG. 4B.

### [1-1. Configuration of Breaker Device]

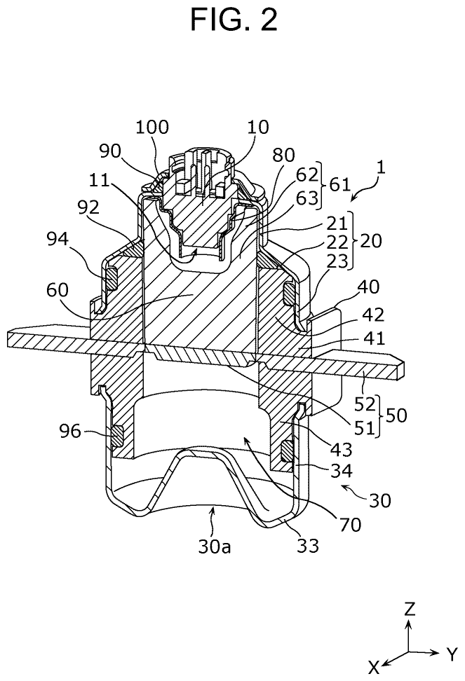

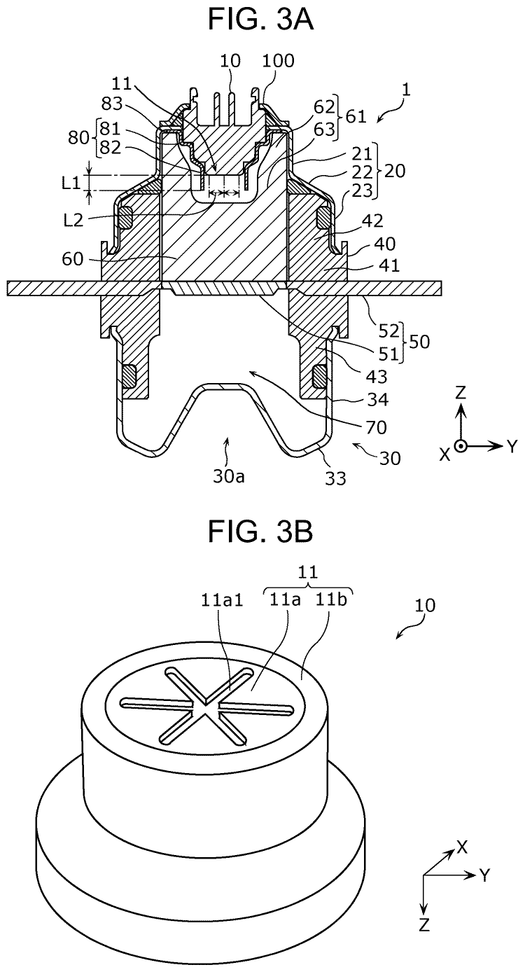

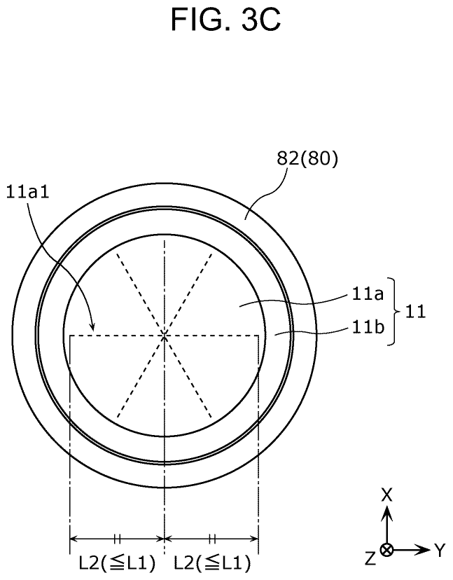

First, the configuration of the breaker device according to the present exemplary embodiment will be described with reference to FIG. 1A to FIG. 3C. FIG. 1A is a first perspective view illustrating breaker device 1 according to the present exemplary embodiment. FIG. 1B is a second perspective view illustrating breaker device 1 according to the present exemplary embodiment. FIG. 2 is a perspective cross-sectional view illustrating breaker device 1 according to the present exemplary embodiment. FIG. 3A is a cross-sectional view illustrating breaker device 1 according to the present exemplary embodiment.

Assuming that a view projected in the X-axis direction is a front view, FIG. 1A illustrates breaker device 1 that has rotated around the Z-axis as an axis of rotation from the state thereof in a front view, and FIG. 1B illustrates breaker device 1 viewed obliquely from below. FIG. 2 is a perspective view illustrating a cross-section of breaker device 1 (in the initial state) that has not performed the interrupting operation and is cut along the YZ plane, and FIG. 3A is a front view illustrating a cross-section of breaker device 1 (in the initial state) that has not performed the interrupting operation and is cut along the YZ plane.

As illustrated in FIG. 1A to FIG. 3A, breaker device 1 includes igniter 10, upper casing 20, lower casing 30, resin member 40, conductor 50, pusher 60, protective portion 80, and elastic members 90, 92, 94, 96. Breaker device 1 is a device that is mounted on an object including an electrical circuit and operates to interrupt the electrical circuit when an anomaly occurs in the electrical circuit, a system, or the like in the object, to thereby prevent damage caused by the anomaly from becoming severe. For example, breaker device 1 is mounted on a vehicle, which is one example of the object, and is connected between a motor and a battery (for example, a lithium-ion battery) for driving the motor to interrupt the electrical connection between the motor and the battery for driving the motor in the event of emergency situations such as malfunctions and accidents. Note that the object may be other than a vehicle; examples of the object include, but are not particularly limited to, a home appliance and a photovoltaic system.

Igniter 10 holds gunpowder inside, includes lid portion 11 between the gunpowder and pusher 60, is disposed inside recessed portion 61, and generates gas. For example, igniter 10 is an electric igniter including: a gunpowder portion including an ignition charge; and a conducting pin for passing an electric current through the gunpowder portion. During operation, an operating current for igniting the ignition charge is supplied from an external power supply to the conducting pin, thus the ignition charge is ignited and burnt, and gas (combustion gas) is generated. Note that when recessed portion 61 is formed, breaker device 1 can be reduced in size.

Igniter 10 is fixed to small-diameter portion 21 located at the top of upper casing 20.

Next, lid portion 11 will be described further with reference to FIG. 3B and FIG. 3C. FIG. 3B is a perspective view illustrating a part of igniter 10 according to the present exemplary embodiment that has not generated gas yet. FIG. 3C is a plan view of lid portion 11 of igniter 10 and protective portion 80 according to the present exemplary embodiment in the state where igniter 10 has not generated gas yet. FIG. 3C is a schematic diagram of lid portion 11 (opening portion 11a and outer frame portion 11b) and second cylindrical portion 82 as viewed from the negative side of the Z-axis to the positive side of the Z-axis. The phrase “having not generated gas yet” indicates “before the interrupting operation.”

As illustrated in FIG. 3B and FIG. 3C, lid portion 11 includes opening portion 11a and outer frame portion 11b. In FIG. 3C, cutout 11a1 is schematically indicated by the dashed lines. Lid portion 11 is formed of, but not limited to, a metal.

Opening portion 11a is a part that is disposed so as to open on the negative side of the Z-axis and when receiving the pressure of the gas, opens downward. Opening portion 11a is in the shape of a flat surface, for example, but may be in the shape of a curved surface. Furthermore, cutout 11a1 (groove) is formed in opening portion 11a so that opening portion 11a can open smoothly.

Note that in FIG. 3B and FIG. 3C, cutout 11a1 is configured not to be in contact with outer frame portion 11b, but cutout 11a1 may be configured to be in contact with outer frame portion 11b.

Outer frame portion 11b is a cylindrical member that surrounds opening portion 11a in plan view.

Note that lid portion 11 may be covered by a resin or the like. In other words, lid portion 11 and protective portion 80 may be electrically insulated in the initial state.

Length L2 indicated in FIG. 3C is half of the length of cutout 11al of opening portion 11a. Note that there are cases where length L2 is equal to half of the diameter of opening portion 11a.

Note that the shape of opening portion 11a in plan view is not limited to a circle and may be an ellipse, a rectangle, or the like.

With reference back to FIG. 1A to FIG. 2, upper casing 20 and lower casing 30, which are members constituting the outer full of breaker device 1, house a portion of each of igniter 10, resin member 40, and conductor 50, pusher 60, and protective portion 80.

Space 70 extending in the up-down direction is formed inside upper casing 20 and lower casing 30. Space 70 is a space formed in the shape of a cylinder so that pusher 60 can move therein. Pusher 60 is housed in an area of space 70 that is located at the upper end (on the positive side of the Z-axis) in the up-down direction (the Z-axis direction).

Each of upper casing 20 and lower casing 30 is formed of a metal such as stainless steel (SUS), but may be formed of other metals such as aluminum. The outer shape of each of upper casing 20 and lower casing 30 is, but not limited to, a circular column.

Upper casing 20 and lower casing 30 are fixed using fastening members such as screws and rivets. Each of upper casing 20 and lower casing 30 is one example of the casing.

Upper casing 20, which is a cylinder member having the shape of a circular cylinder with a step, for example, is hollow inside. Upper casing 20 includes: small-diameter portion 21 located in an upper area; large-diameter portion 23 located in a lower area; and connecting portion 22 that connects these small-diameter and large-diameter portions. Small-diameter portion 21 and large-diameter portion 23 are coaxially disposed, and large-diameter portion 23 is larger in diameter than small-diameter portion 21.

Lower casing 30, which is a member having the shape of a hollow cylinder with a closed bottom, includes projecting portion 30a that protrudes upward. Specifically, lower casing 30 includes projecting portion 30a, bottom portion 33, and side wall portion 34.

Projecting portion 30a, bottom portion 33, and side wall portion 34 are integrally formed.

Note that in the present specification, being integrally formed means at least one of the following: that components are formed of the same material; that components are formed at the same time; and that components are the same object (a single object), for example.

Projecting portion 30a is located below separating portion 51 and configured so as to protrude upward in space 70. Projecting portion 30a is connected to one end of bottom portion 33 and protrudes upward (on the positive side of the Z-axis) from bottom portion 33 in space 70. Projecting portion 30a is configured so as to contact, via conductor 50, pusher 60 that has moved downward by the gas generated by igniter 10 and then deform downward by being pressed by pusher 60. This means that projecting portion 30a has the function of absorbing the impact (stress) from pusher 60 by deformation.

Projecting portion 30a, which forms the recessed portion of lower casing 30 when breaker device 1 is viewed from the negative side of the Z-axis to the positive side of the Z-axis, is exposed as viewed from the outside of breaker device 1. In the present exemplary embodiment, projecting portion 30a is tapered upward in space 70, but the shape of projecting portion 30a is not limited to this tapered shape.

Bottom portion 33 connects projecting portion 30a and side wall portion 34. In other words, projecting portion 30a and side wall portion 34 are connected via bottom portion 33. Bottom portion 33 has an outer surface and an inner surface each inclined upward from projecting portion 30a to side wall portion 34.

Side wall portion 34 is connected to the other end of bottom portion 33 and is formed so as to extend upward from bottom portion 33. Side wall portion 34 has the shape of a cylinder; in the present exemplary embodiment, side wall portion 34 has the shape of a circular cylinder. Side wall portion 34 is disposed coaxially with small-diameter portion 21 and large-diameter portion 23. The diameter of side wall portion 34 is equal to the diameter of large-diameter portion 23, for example.

Projecting portion 30a, bottom portion 33, and side wall portion 34 have the same thickness in the present exemplary embodiment, but may have different thicknesses, for example.

Resin member 40 is a member that covers a part of conductor 50. Resin member 40 is a part of structural elements that form space 70. Resin member 40 includes embedding portion 41, first cylindrical portion 42, and second cylindrical portion 43.

Embedding portion 41 is a part of resin member 40 in which conductor 50 is embedded. Embedding portion 41 is partially exposed from the casing, for example.

Embedding portion 41 has a through-hole in which conductor 50 (specifically, holding portion 52) is disposed.

First cylindrical portion 42, which is a part of resin member 40 that is disposed in the casing, is where pusher 60 is disposed during a non-interrupting operation (while no gas is generated by igniter 10). The inner diameter of first cylindrical portion 42 is less than the inner diameter of second cylindrical portion 43. Note that the position of pusher 60 illustrated in FIG. 2 and FIG. 3A indicates the initial position assumed during a non-interrupting operation.

Second cylindrical portion 43, which is a part of resin member 40 that is disposed in the casing, is a part located at a level below first cylindrical portion 42. The inner diameter of second cylindrical portion 43 is greater than the inner diameter of first cylindrical portion 42. Thus, the volume of the lower area of space 70 can be made large. This makes it possible to reduce an increase in the pressure inside the casing that is caused by the gas generated by igniter 10 and the following movement of pusher 60, meaning that the deformation of breaker device 1 can be minimized.

In this manner, pusher 60 moves in space 70 formed by first cylindrical portion 42 and second cylindrical portion 43. Note that first cylindrical portion 42 and second cylindrical portion 43 are not limited to having different inner diameters and may have the same inner diameter.

Conductor 50 is an electrically conductive metal body that is partially located in upper casing 20 and lower casing 30. When breaker device 1 is mounted on a predetermined electrical circuit, conductor 50 forms a part of said electrical circuit and is also referred to as a busbar. Conductor 50 is a flat member held on resin member 40 and disposed so as to cross the interior of each of upper casing 20 and lower casing 30. Conductor 50 includes separating portion 51 and holding portion 52.

Conductor 50 can be formed of a metal such as copper (Cu), for example. Note that conductor 50 may be formed of a metal other than copper or may be formed of an alloy of copper and another metal. For example, conductor 50 may contain manganese (Mn), nickel (Ni), platinum (Pt), or the like.

Separating portion 51, which is a part of conductor 50 to be cut off by pusher 60 under the pressure of the gas generated by igniter 10, is located below pusher 60 at the initial position.

Holding portion 52 is a part of conductor 50 that is held by resin member 40.

Holding portion 52 is a part that does not overlap pusher 60 in plan view; for example, holding portion 52 is a part that overlaps resin member 40 and is a part located outside of the casing in plan view. Holding portion 52 remains held by resin member 40 even after separating portion 51 is cut off.

Pusher 60 is positioned below igniter 10 and disposed so as to be able to move downward and, for example, when an anomaly occurs in the system, moves downward to cut conductor 50 and interrupt the flow of an electric current through the electrical circuit as an emergency measure. Thus, pusher 60 is configured so as to cut off separating portion 51 from conductor 50 by receiving the pressure of the gas generated by igniter 10.

Pusher 60 is formed of an insulating member such as a synthetic resin, for example. In the present exemplary embodiment, pusher 60 is formed of nylon. Pusher 60 has the shape of a circular column with an outer diameter corresponding to the inner diameter of small-diameter portion 21 of upper casing 20. Pusher 60 includes recessed portion 61, and igniter 10 is disposed inside recessed portion 61. Note that the shape of pusher 60 is not limited to said shape and can be changed, as appropriate, according to the shape, etc., of each of upper casing 20 and lower casing 30. Recessed portion 61 is an upper portion of pusher 60 where a recess directed downward is provided.

In the example illustrated in FIG. 2, recessed portion 61 is a part with a lateral surface surrounded by small-diameter portion 21 and connecting portion 22 in the state where breaker device 1 has not performed the interrupting operation (the state illustrated in FIG. 2).

Recessed portion 61 includes, in plan view: first section 62 having a diameter (for example, an inner diameter) greater than the diameter of first cylindrical portion 81 of protective portion 80; and second section 63 located at a level below first section 62 and having a diameter (for example, an inner diameter) greater than the diameter of second cylindrical portion 82. In plan view, the diameter of first section 62 is greater than the diameter of second section 63. For example, in a cross-sectional view, the inner wall of first section 62 is tapered with a diameter reduced toward second section 63, but may be, for example, in the shape of a staircase with a diameter reduced stepwise.

Protective portion 80 is a structural element for protecting pusher 60 from being damaged by opening portion 11a of igniter 10 when igniter 10 generates gas. Specifically, protective portion 80 is a member serving as a barrier to opening portion 11a that may open wide, to reduce the occurrence of opening portion 11a opened as a result of the gas generation by igniter 10 coming into contact with pusher 60 and damaging recessed portion 61 of pusher 60.

Protective portion 80 is provided on the casing (for example, upper casing 20) or igniter 10 and includes a part located inside recessed portion 61. In the present exemplary embodiment, protective portion 80 is provided on the casing (specifically, small-diameter portion 21). Protective portion 80 is fixed to small-diameter portion 21 by welding, for example, but the fixing method is not limited to welding.

As illustrated in FIG. 3A, etc., protective portion 80 includes first cylindrical portion 81 and second cylindrical portion 82. First cylindrical portion 81 and second cylindrical portion 82 are integrally formed.

First cylindrical portion 81, which is a part in the shape of a cylinder surrounding the lateral side of igniter 10, has a shape corresponding to igniter 10. In the present exemplary embodiment, first cylindrical portion 81 is formed in the shape of a staircase (for example, in the form of a two-step staircase) with a diameter (for example, an inner diameter) reduced stepwise downward in a cross-sectional view. Note that the shape of first cylindrical portion 81 is not limited to this shape; for example, first cylindrical portion 81 may be tapered with a diameter reduced downward or may have another shape.

First cylindrical portion 81 may be at least partially in contact with igniter 10.

Second cylindrical portion 82 is disposed at a level below first cylindrical portion 81.

First cylindrical portion 81 includes flange portion 83 at the top. Flange portion 83, which is a ring-shaped part (for example, a plate-shaped member) formed so as to protrude outward from the upper end of first cylindrical portion 81 in plan view, is fixed to small-diameter portion 21 by welding or the like. At least a part of flange portion 83 is disposed between first section 62 and small-diameter portion 21, for example. Thus, first cylindrical portion 81 includes a part connected to the casing and is fixed to the casing.

Second cylindrical portion 82 is a ring-shaped part located at a level below first cylindrical portion 81 and having a diameter (for example, an inner diameter) less than the diameter of first cylindrical portion 81. Second cylindrical portion 82 is a part that protrudes straight from the lower end of first cylindrical portion 81 on the negative side of the Z-axis and when the gas is generated, comes into contact with lid portion 11. The lower end (the end located on the negative side of the Z-axis, that is, the lowest end, for example) of second cylindrical portion 82 is located at a level below (on the negative side of the Z-axis from) the lower end (the end located on the negative side of the Z-axis, that is, the lowest end, for example) of lid portion 11 (refer to FIG. 3A) in the state where no gas is generated. For example, as illustrated in FIG. 3A, length L1 from the lower end of lid portion 11 in second cylindrical portion 82 to the lower end of second cylindrical portion 82 is greater than or equal to length L2 of cutout 11a1 of lid portion 11. Second cylindrical portion 82 is not in contact with pusher 60.

Protective portion 80 is formed of a metal such as stainless steel (SUS), for example, but may be formed of other metals such as aluminum or may be formed of a resin (for example, a resin different from that of pusher 60).

As illustrated in FIG. 2, etc., elastic members 90, 92, 94, 96, which are members with elasticity such as rubber, are O-rings each formed in the shape of a ring.

Elastic member 90 is disposed in the space formed between small-diameter portion 21, igniter 10, and fixing member 100 for fixing igniter 10 disposed inside recessed portion 61. Elastic member 90 is in contact with each of fixing member 100, igniter 10, and small-diameter portion 21 and, for example, is pressed by each of fixing member 100, igniter 10, and small-diameter portion 21.

Elastic member 92 is disposed in the space formed between the casing (for example, connecting portion 22), pusher 60, and resin member 40 in order to keep the internal space of recessed portion 61 and conductor 50 from being spatially connected.

Elastic member 92 keeps the gas generated by igniter 10 from reaching conductor 50. In the present exemplary embodiment, elastic member 92 is in contact with the casing, pusher 60, and resin member 40 and, for example, is pressed by each of the casing, pusher 60, and resin member 40.

Elastic member 94 is disposed in the space formed above conductor 50, between the casing (for example, large-diameter portion 23) and a circumferential recessed portion formed on resin member 40, in order to keep the exterior space and the space located above conductor 50 from being spatially connected. In the present exemplary embodiment, elastic member 94 is in contact with each of resin member 40 and large-diameter portion 23 and, for example, is pressed by each of resin member 40 and large-Diameter

### Portion 23.

Elastic member 96 is disposed in the space formed below conductor 50, between lower casing 30 (for example, side wall portion 34) and a circumferential recessed portion formed on resin member 40, in order to keep the exterior space and the space located below conductor 50 from being spatially connected. In the present exemplary embodiment, elastic member 96 is in contact with each of resin member 40 and side wall portion 34 and, for example, is pressed by each of resin member 40 and side wall portion 34.

Note that elastic members 94, 96 are not limited to being disposed in the circumferential recessed portions without spacing; spacing may be formed in at least one of the up and down directions.

### [1-2. Interrupting Operation]

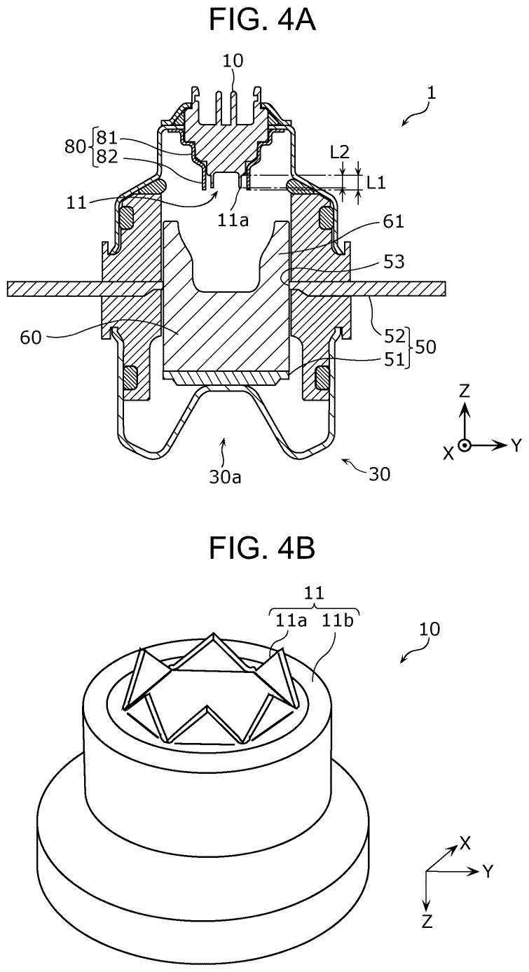

Next, the interrupting operation of breaker device 1 configured as described above will be described with reference to FIG. 4A and FIG. 4B. FIG. 4A is a cross-sectional view for describing an interrupting operation of breaker device 1 according to the present exemplary embodiment. FIG. 4A illustrates a cross-sectional configuration of breaker device 1 that has performed the interrupting operation. FIG. 4B is a perspective view illustrating a part of lid portion 11 of igniter 10 according to the present exemplary embodiment that has generated gas.

Note that FIG. 4A and FIG. 4B show the state where opening portion 11a is open in the Z-axis direction and opening portion 11a has reached the lowest position, for the sake of convenience. Therefore, opening portion 11a and protective portion 80 illustrated in FIG. 4A are not in contact, but in actuality, opening portion 11a opens so as to contact second cylindrical portion 82. Furthermore, although FIG. 4B shows an ideal opening state of opening portion 11a cut along cutout 11al when gas is generated, opening portion 11a is not necessarily cut neatly along cutout 11al in actual products. In what state opening portion 11a opens depends on the amount of gunpowder or the like, for example.

As illustrated in FIG. 4A, when igniter 10 operates, the upper surface (the pressure-receiving surface) of pusher 60 receives the pressure of energy from igniter 10, thus pusher 60 moves downward at high speed from the initial position illustrated in FIG. 3A, cuts off separating portion 51 from holding portion 52, and moves further downward at high speed integrally with cut-off separating portion 51, and separating portion 51 comes into contact with projecting portion 30a. Thus, pusher 60 can cut conductor 50 forcibly and physically.

Projecting portion 30a deforms downward by being pressed by pusher 60. Thus, projecting portion 30a can absorb the impact (stress) from pusher 60 by deformation.

Furthermore, even when pusher 60 moves further downward, a part of pusher 60 (for example, at least a part of recessed portion 61) is located at a level above cut surface 53.

As a result, the insulation distance between cut surfaces 53 of conductor 50 can be increased and thus, it is possible to reduce the occurrence of an electric arc when conductor 50 is cut.

Length L1 illustrated in FIG. 4A and FIG. 3C is the distance from the lower end of lid portion 11 to the lower end of protective portion 80. Length L2 is half of the length of cutout 11a1 of opening portion 11a, as mentioned above. Length L2 is less than or equal to length L1. According to this length relationship, when opening portion 11a opens downward, protective portion 80 serves as a barrier to opening portion 11a that may open wide, reducing the occurrence of opening portion 11a opened coming into contact with recessed portion 61 of pusher 60.

Note that as illustrated in FIG. 4A, protective portion 80 is stationary and does not move together with pusher 60 in the interrupting operation.

### Various Variations of Embodiment 1

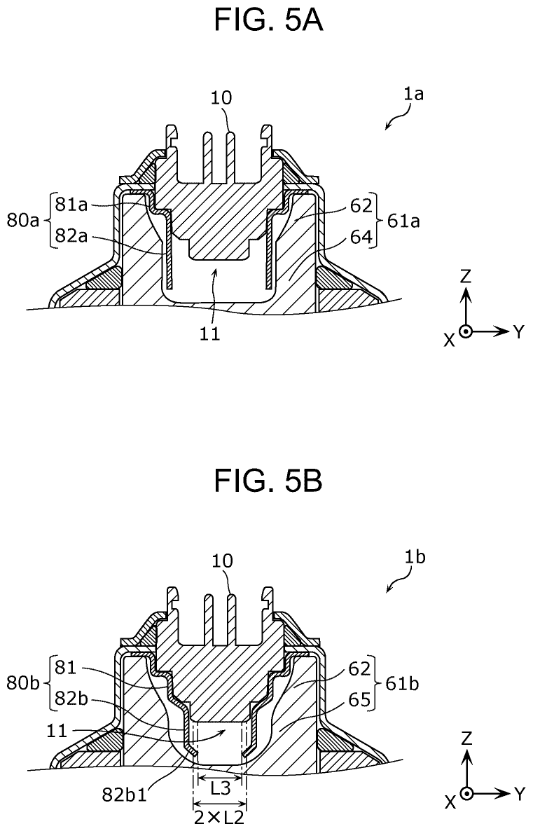

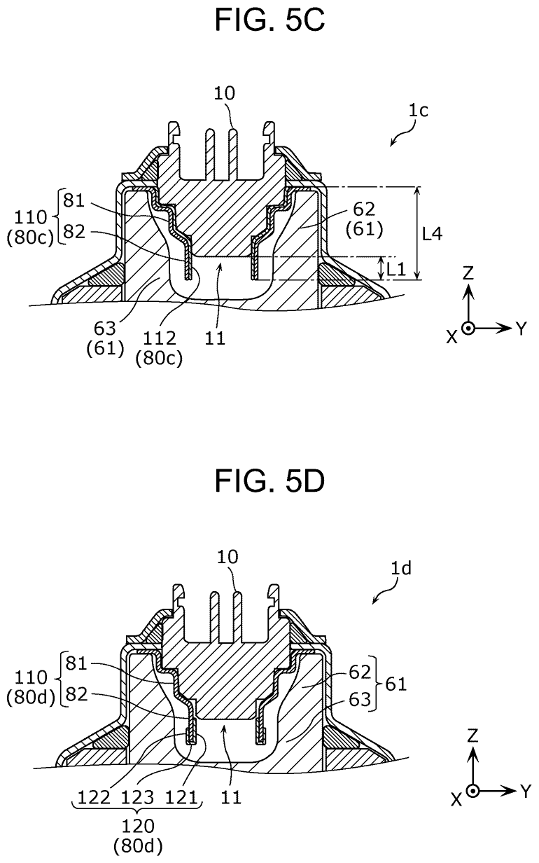

Hereinafter, various variations applicable to Embodiment 1 will be described with reference to FIG. 5A to FIG. 5D. Note that the following description will focus on differences from Embodiment 1, and description of details that are the same as or similar to those described in Embodiment 1 will be omitted or simplified.

FIG. 5A to FIG. 5D are cross-sectional views illustrating breaker devices according to variations of Embodiment 1. The breaker devices illustrated in FIG. 5A to FIG. 5D are different from breaker device 1 according to Embodiment 1 in that the protective portion has a different shape, for example.

As illustrated in FIG. 5A, protective portion 80a of breaker device la includes first cylindrical portion 81a and second cylindrical portion 82a.

First cylindrical portion 81a is a part in the shape of a cylinder surrounding the lateral side of igniter 10, and at least a part of first cylindrical portion 81a has a shape corresponding to igniter 10. In the present exemplary embodiment, first cylindrical portion 81a is formed in the shape of a staircase (for example, in the form of a one-step staircase) with a diameter (for example, an inner diameter) reduced stepwise downward in a cross-sectional view.

Second cylindrical portion 82a is a part in the shape of a cylinder located at a level below first cylindrical portion 81a and having a diameter (for example, an inner diameter) less than that of first cylindrical portion 81a. Second cylindrical portion 82a protrudes straight from the lower end of first cylindrical portion 81a on the negative side of the Z-axis, and the length of second cylindrical portion 82a in the Z-axis direction is greater than the length of first cylindrical portion 81a in the Z-axis direction, for example. The lower end (the end located on the negative side of the Z-axis, that is, the lowest end, for example) of second cylindrical portion 82a is located at a level below (on the negative side of the Z-axis from) the lower end (the end located on the negative side of the Z-axis, that is, the lowest end, for example) of lid portion 11 (refer to FIG. 3A) in the state where no gas is generated.

Protective portion 80a configured as just described is easily manufactured because the number of steps of first cylindrical portion 81a in the shape of a staircase is less than the number of steps of igniter 10 and the straight portion of protective portion 80a is long.

Recessed portion 61a includes first section 62 and second section 64.

First section 62 is a part having a diameter (for example, an inner diameter) reduced downward at a predetermined rate of curvature.

Second section 64 is a part located at a level below first section 62 and having an inner surface parallel to the Z-axis direction in a cross-sectional view. Second section 64 is provided so as to face at least part of second cylindrical portion 82a in a cross-sectional view.

The shape of recessed portion 61a may correspond to the shape of protective portion 80a.

As illustrated in FIG. 5B, protective portion 80b of breaker device 1b includes first cylindrical portion 81 and second cylindrical portion 82b.

Second cylindrical portion 82b is a part in the shape of a cylinder located at a level below first cylindrical portion 81 and having a diameter (for example, an inner diameter) less than that of first cylindrical portion 81. Second cylindrical portion 82b protrudes on the negative side of the Z-axis from the lower end of first cylindrical portion 81 and includes inclined portion 82b1 which is a lower end portion inclined inward. It can also be said that the lower end portion of second cylindrical portion 82b is bent inward. The shape, orientation, etc., of inclined portion 82b1 are not particularly limited as long as inclined portion 82b1 is provided protruding inward at an angle with respect to the Z-axis direction in a cross-sectional view.

The diameter (length L3) of the lower opening of second cylindrical portion 82b is less than the length (2×L2) of cutout 11a1 (refer to FIG. 3C), for example. Length L3 is the shortest distance between the leading ends of inclined portion 82b1. The diameter of opening portion 11a corresponds to the diameter of lid portion 11.

Second cylindrical portion 82b is a part that comes into contact with lid portion 11 when gas is generated, for example. The lower end (the end located on the negative side of the Z-axis, that is, the lowest end, for example) of second cylindrical portion 82b is located at a level below (on the negative side of the Z-axis from) the lower end (the end located on the negative side of the Z-axis, that is, the lowest end, for example) of lid portion 11 in the state where no gas is generated.

Thus, when protective portion 80b includes inclined portion 82b1, the pressure of the gas generated by igniter 10 can be concentrated at a more inward position and therefore, the amount of gunpowder can be reduced.

Recessed portion 61b includes first section 62 and second section 65.

Second section 65 is located at a level below first section 62 and has a shape (a curved shape) corresponding to second cylindrical portion 82b. For example, second section 65 has a shape corresponding to inclined portion 82b1, and second section 65 in an area corresponding to inclined portion 82b1 can be made thick in a direction perpendicular to the Z-axis as compared to when second cylindrical portion 82b is formed of a straight portion only. Thus, it is possible to improve the strength of recessed portion 61 of pusher 60.

As illustrated in FIG. 5C, protective portion 80c of breaker device 1c includes metal portion 110 and resin portion 112. Protective portion 80c has a double structure of metal portion 110 and resin portion 112. The configuration of metal portion 110 is the same as the configuration of protective portion 80 described above, and description thereof will be omitted. Note that metal portion 110 and resin portion 112 are integrally formed, for example. Resin portion 112 may be formed on the inner surface of metal portion 110 by coating or the like, for example. Resin portion 112 may be, for example, applied to a surface of metal portion 110. Note that being integrally formed means two elements being integrally formed, that is, attaching one of the elements to the other so that the elements are not detachable.

Note that metal portion 110 and resin portion 112 are not limited to being integrally formed and may be separate bodies one of which is detachably attached to the other. When metal portion 110 and resin portion 112 are detachable (are separate members), metal portion 110 is one example of the metal member, and resin portion 112 is one example of the resin member. The resin member may be, for example, a resin sheet member disposed along the metal member. Note that being detachable means that metal portion 110 and resin portion 112 are connected in such a manner that these can be attached and detached without breakage or plastic deformation.

Resin portion 112 covers an area of the inner surface of metal portion 110 that is located at a level below lid portion 11. In the present exemplary embodiment, resin portion 112 covers the entire inner surface of metal portion 110. The distance from the lower end of lid portion 11 to the lower end of resin portion 112 (length L1 herein) is greater than or equal to half of the size of opening portion 11a of lid portion 11. In the example illustrated in FIG. 5C, the distance from the lower end of lid portion 11 to the lower end of resin portion 112 and the distance from the lower end of lid portion 11 to the lower end of metal portion 110 are equal, both of which are length L1, for example. The vertical length from the upper end of resin portion 112 to the lower end of resin portion 112 is length L4.

As illustrated in FIG. 5D, protective portion 80d of breaker device 1d includes metal portion 110 and resin portion 120.

Resin portion 120 covers an area of the inner surface of metal portion 110 that is located at a level below lid portion 11. In the present exemplary embodiment, resin portion 120 fits in metal portion 110 and is fixed thereto so as to cover a lower end portion (leading end portion) of metal portion 110. The inner surface of resin portion 120 contacts the outer surface of metal portion 110. Metal portion 110 is one example of the metal member, and resin portion 120 is one example of the resin member.

Resin portion 120 includes: first portion 121 disposed inward of metal portion 110; second portion 122 disposed outward of metal portion 110; and third portion 123 that connects first portion 121 and second portion 122. At least a part of third portion 123 is located at a level below metal portion 110. This means that the lower end of metal portion 110 is not exposed. Resin portion 120 is a cap-shaped member and a cross-section thereof is, for example, U-shaped.

The vertical length from the upper end to the lower end of first portion 121 may be greater than the vertical length from the lower end of lid portion 11 to the lower end of second cylindrical portion 82, for example. The vertical length from the upper end to the lower end of second portion 122 may be less than the vertical length from the lower end of lid portion 11 to the lower end of second cylindrical portion 82, for example.

Note that resin portion 120 may be formed by coating or the like so as to cover the lower end portion of metal portion 110 from the inner surface to the outer surface thereof.

### Manufacturing Method

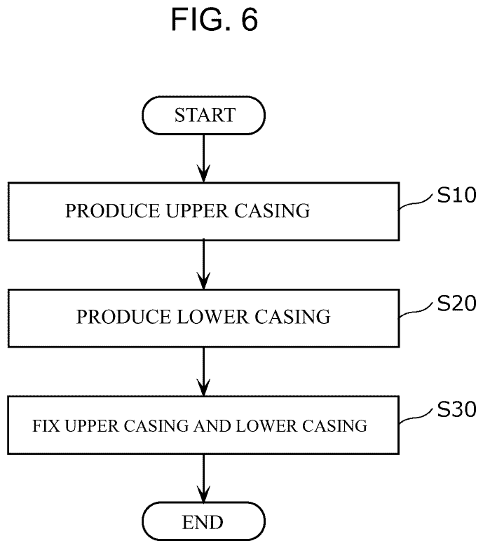

Next, the method for manufacturing the breaker devices according to Embodiment 1 and various variations thereof configured as described above will be described with reference to FIG. 6. FIG. 6 is a flowchart illustrating a manufacturing process of breaker device 1 according to Embodiment 1. FIG. 6 illustrates the manufacturing process of breaker device 1 according to Embodiment 1.

As illustrated in FIG. 6, upper casing 20 is produced by molding or the like (S10), and lower casing 30 is produced by molding or the like (S20). Note that Step S10 may be performed after Step S20.

In Step S10, protective portion 80 is further provided on upper casing 20. For example, protective portion 80 is fixed to upper casing 20 by welding or the like.

Furthermore, in Step S20, projecting portion 30a is formed at the same time as lower casing 30 is produced by molding.

Next, upper casing 20 and lower casing 30 are fixed (S30). For example, upper casing 20 and lower casing 30 are fixed without gaps by fastening members or the like in the state where igniter 10, resin member 40, conductor 50, pusher 60, and protective portion 80 are housed in the casings. As a result, breaker device 1 described above is produced.

### Embodiment 2

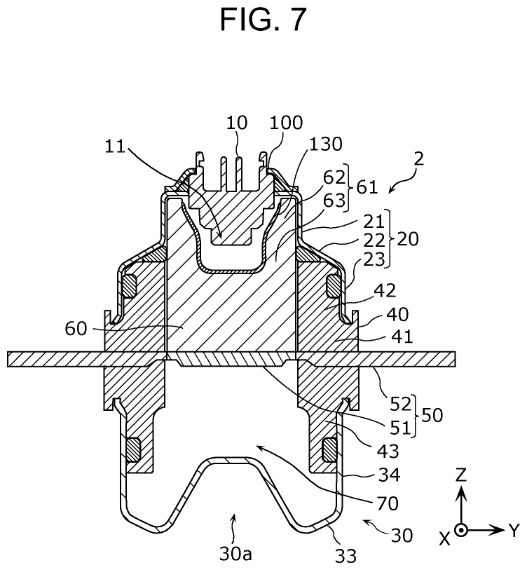

Hereinafter, a breaker device according to the present exemplary embodiment will be described with reference to FIG. 7. Note that the following description will focus on differences from Embodiment 1, and description of details that are the same as or similar to those described in Embodiment 1 will be omitted or simplified.

FIG. 7 is a cross-sectional view illustrating breaker device 2 according to the present exemplary embodiment. Breaker device 2 according to the present exemplary embodiment is different from breaker device 1 according to Embodiment 1 in that protective portion 130 is provided on the pusher 60 side.

As illustrated in FIG. 7, breaker device 2 according to the present exemplary embodiment includes protective portion 130 instead of protective portion 80 in breaker device 1 according to Embodiment 1.

Protective portion 130 is provided so as to cover the inner surface of recessed portion 61 of pusher 60. Protective portion 130 may be provided so as to contact and cover the inner surface of recessed portion 61, for example. Protective portion 130 may be provided so as to cover an area of the inner surface of recessed portion 61 that is located at a level below lid portion 11, for example. For example, protective portion 130 may be provided so as to cover the entire inner surface of recessed portion 61 that is located at a level below lid portion 11. Furthermore, protective portion 130 may be provided at a position between lid portion 11 and pusher 60, for example. Note that covering the entire inner surface herein includes, in addition to completely covering the entire inner surface, covering substantially the entire inner surface (for example, covering at least 80% of the surface area of the inner surface).

Protective portion 130 is a metal layer formed of a metal or an insulating layer formed of an insulating material. For example, when protective portion 130 is a metal layer, protective portion 130 is formed of a metal such as stainless steel (SUS), but may be formed of other metals such as aluminum. When protective portion 130 is a metal layer, it is possible to improve the strength of protective portion 130, and thus it is possible to more reliably reduce the occurrence of damage to pusher 60. When protective portion 130 is an insulating layer, for example, protective portion 130 may be formed of a material different from the material of pusher 60. For example, when protective portion 130 is an insulating layer, protective portion 130 may be formed of a harder material than the material of pusher 60. The insulating layer may be formed of silicon oxide such as SiO₂, silicon nitride such as SiN, or silicon oxynitride such as SiON. When protective portion 130 is an insulating layer, it is possible to reduce the occurrence of electrical conduction between opening portion 11a and the casing via protective portion 130.

Protective portion 130 is formed integrally with pusher 60 by applying coating or the like to the inner surface of recessed portion 61, for example.

Note that protective portion 130 is not limited to being formed integrally with pusher 60 and may be separate from pusher 60. Protective portion 130 may be a separate body having a shape corresponding to the inner surface of recessed portion 61, for example. For example, protective portion 130 may be placed on the inner surface of recessed portion 61 or may be provided apart from the inner surface of recessed portion 61. In the former case, the inner surface of recessed portion 61 and protective portion 130 are in surface contact, for example.

Thus, when protective portion 130 and pusher 60 are not integrally formed, protective portion 130 is one example of the metal member formed of a metal layer or the insulating member formed of an insulating layer made from a material different from the material of pusher 60. In other words, protective portion 130 is a metal member or an insulating member disposed inside recessed portion 61, and the metal member or the insulating member may be provided at a position between lid portion 11 and pusher 60.

Note that protective portion 130 may have a double structure in which the insulating layer is formed above the metal layer.

In the present exemplary embodiment, protective portion 130 moves downward together with pusher 60 in the interrupting operation.

Even in such breaker device 2, protective portion 130 can reduce the occurrence of opening portion 11a opened as a result of the gas generation by igniter 10 coming into contact with pusher 60 and damaging recessed portion 61 of pusher 60, as in Embodiment 1.

### Configuration of Another Breaker Device

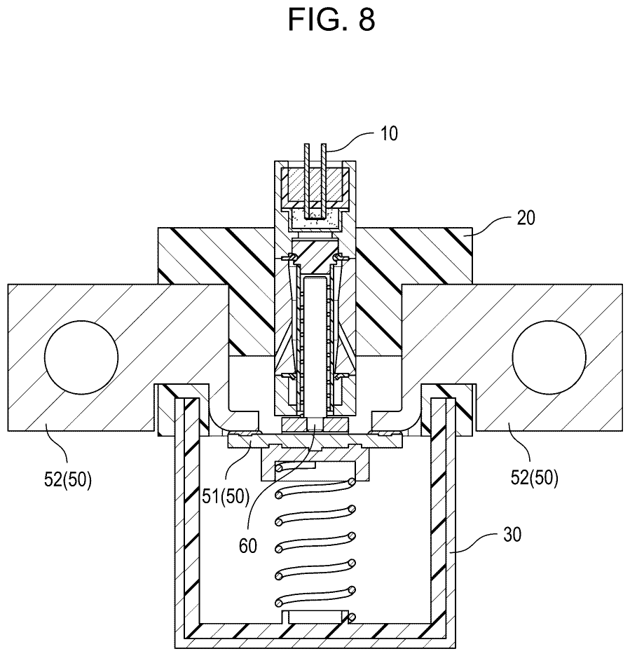

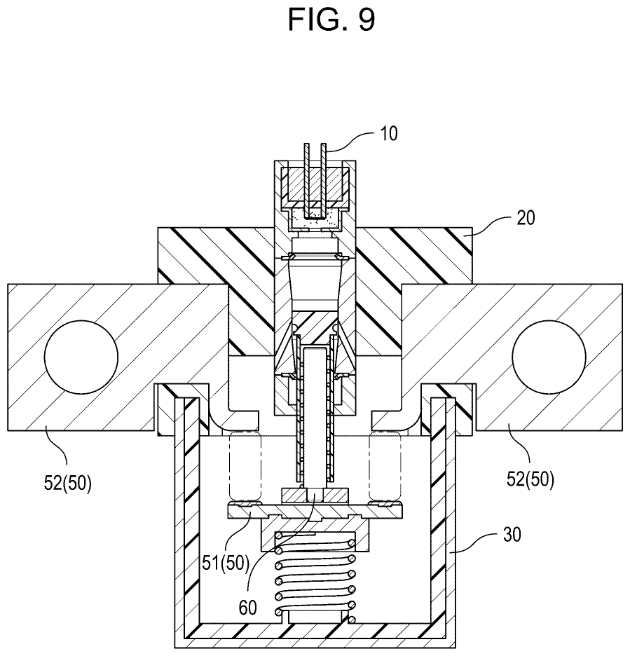

A breaker device in which separating portion 51 has a different structure will be described with reference to FIG. 8 and FIG. 9. FIG. 8 is a cross-sectional view illustrating a breaker device according to another exemplary embodiment. FIG. 9 is a cross-sectional view for describing a situation in which the separating portion in the breaker device according to another exemplary embodiment illustrated in FIG. 8 has moved downward.

Note that in FIG. 8 and FIG. 9, elements that are substantially the same as those in breaker devices 1, 1a, 1b, 1c, 1d, 2 described above will be assigned the same reference signs as those in breaker devices 1, 1a, 1b, 1c, 1d, 2, and description of the elements will be omitted.

In breaker device 1 described above, pusher 60 receives the pressure of the gas generated by igniter 10 and cuts off separating portion 51 from conductor 50 and thus, separating portion 51 moves downward. In other words, when separating portion 51 is cut off from holding portion 52, the electrical connection between separating portion 51 and holding portion 52 is cut and as a result, conductor 50 becomes non-conducting. However, the breaker device according to the present disclosure does not necessarily need to be configured to cut off separating portion 51.

For example, as illustrated in FIG. 7 and FIG. 8, pusher 60 may move the separating portion downward by receiving the pressure of the gas generated by igniter 10, and thereby place conductor 50 in a non-conducting state. In other words, separating portion 51 in contact with holding portion 52 may be moved downward so that separating portion 51 is separated from holding portion 52, to place conductor 50 in a non-conducting state.

### Other Exemplary Embodiments

The breaker devices according to one or more aspects have been described thus far based on the exemplary embodiments, etc., but the present disclosure is not limited to these exemplary embodiments, etc. Various modifications to the present exemplary embodiments and forms configured by combining structural elements in different exemplary embodiments that can be conceived by those skilled in the art may be included within the present disclosure as long as these do not depart from the essence of the present disclosure.

For example, the above exemplary embodiments, etc., describe examples in which the casing is made from a metal, but this is not limiting; for example, the lower casing included in the casing may be made from a resin with deformation properties.

The conditions (the number, the shape, and the like) of the cutout illustrated in FIG. 3B and FIG. 3C in Embodiment 1 described above are one example and are not limited to those illustrated, as long as the lid portion can be placed in a desired open state. The cutout does not need to be provided in the lid portion. Although opening portion 11a is split only at the position of cutout 11al in FIG. 4B, the split may reach outer frame portion 11b in actual products. In other words, opening portion 11a in actual products may be larger than opening portion 11a illustrated in FIG. 4B.

Furthermore, in the exemplary embodiments, etc., described above, the lower end of the protective portion may be bent outward to the extent that the lower end does not contact the pusher. The term “outward” indicates the direction from the inside of the breaker device to the outside of the breaker device in the plan view of the breaker device.

The order of the steps in the method for manufacturing the breaker device described in the above exemplary embodiments, etc., may be changed. Furthermore, the steps in the method for manufacturing the breaker device described in the above exemplary embodiments may be performed in a single step or may be performed in separate steps.

Note that the phrase “the steps are performed in a single step” is intended to include a situation in which the steps are performed using a single device, a situation in which the steps are sequentially performed, and a situation in which the steps are performed at the same location. The term “separate steps” is intended to include a situation in which the steps are performed using separate devices, a situation in which the steps are performed at different times (for example, on different dates), and a situation in which the steps are performed at different locations.

### INDUSTRIAL APPLICABILITY

The present disclosure is useful in breaker devices, etc., that are disposed in an electrical circuit.

### REFERENCE SIGNS LIST

1, 1a, 1b, 1c, 1d, 2 breaker device
10 igniter
11 lid portion
11a opening portion
11a1 cutout
11b outer frame portion
20 upper casing
21 small-diameter portion
22 connecting portion
23 large-diameter portion
30 lower casing
30a projecting portion
33 bottom portion
34 side wall portion
40 resin member
41 embedding portion
42, 81, 81a first cylindrical portion
43, 82, 82a, 82b second cylindrical portion
50 conductor
51 separating portion
52 holding portion
53 cut surface
60 pusher
61, 61a, 61b recessed portion
62 first section
63, 64, 65 second section
70 space
80, 80a, 80b, 80c, 80d, 130 protective portion
82b1 inclined portion
83 flange portion
90, 92, 94, 96 elastic member
100 fixing member
110 metal portion (metal member)
112, 120 resin portion (resin member)
121 first portion
122 second portion
123 third portion
L1, L2, L3, L4 length

1. A breaker device comprising:
a casing;
a pusher located inside the casing and including a recessed portion;
an igniter storing gunpowder, including a lid portion between the gunpowder and the pusher, being disposed in the recessed portion, and being configured to generate gas;
a protective portion provided to the casing or the igniter and located inside the recessed portion; and
a conductor including a separating portion located below the pusher, wherein
when the pusher receives pressure of the gas generated by the igniter, the pusher moves the separating portion downward,
the lid portion includes an opening portion configured to open by receiving the pressure of the gas, and
a lower end of the protective portion is located at a level below a lower end of the lid portion.

2. The breaker device according to claim 1, wherein
the protective portion includes:
a first cylindrical portion connected to the casing; and
a second cylindrical portion located at a level below the first cylindrical portion and having a diameter less than a diameter of the first cylindrical portion.

3. The breaker device according to claim 2, wherein
the recessed portion of the pusher includes:
a first section having a diameter greater than the diameter of the first cylindrical portion; and
a second section located at a level below the first section and having a diameter greater than the diameter of the second cylindrical portion, and
the diameter of the first section is greater than the diameter of the second section.

4. The breaker device according to claim 2, wherein
a distance between the lower end of the lid portion and a lower end of the second cylindrical portion is greater than or equal to half of a length of a cutout in the opening portion of the lid portion.

5. The breaker device according to claim 2, wherein
a diameter of a lower opening of the protective portion is less than a diameter of the lid portion.

6. The breaker device according to claim 2, wherein
the casing is made from a metal,
the protective portion includes:
a metal member connected to the casing; and
a resin member disposed inward of the metal member,
the metal member includes the first cylindrical portion and the second cylindrical portion, and
a vertical length from an upper end of the resin member to a lower end of the resin member is greater than a vertical length from the lower end of the lid portion to a lower end of the second cylindrical portion.

7. The breaker device according to claim 6, wherein
the resin member includes:
a first portion disposed inward of the metal member;
a second portion disposed outward of the metal member; and
a third portion connecting the first portion and the second portion, and the third portion is located at a level below the metal member.

8. The breaker device according to claim 2, wherein
the protective portion includes a resin portion and a metal portion,
the resin portion and the metal portion are integrally formed, and
the resin portion covers an area of an inner surface of the metal portion that is located at a level below the lid portion.

9. The breaker device according to claim 8, wherein
a distance between the lower end of the lid portion and a lower end of the resin portion is greater than or equal to half of a length of a cutout in the opening portion of the lid portion.

10. The breaker device according to claim 8, wherein
the resin portion includes:
a first portion disposed inward of the metal portion;
a second portion disposed outward of the metal portion; and
a third portion connecting the first portion and the second portion, and the third portion is located at a level below the metal portion.

11. A breaker device comprising:
a casing;
a pusher located inside the casing and including a recessed portion;
an igniter storing gunpowder, including a lid portion between the gunpowder and the pusher, being disposed in the recessed portion, and being configured to generate gas;
a protective portion provided to cover an inner surface of the recessed portion; and
a conductor including a separating portion located below the pusher, wherein
when the pusher receives pressure of the gas generated by the igniter, the pusher moves the separating portion downward.

12. The breaker device according to claim 11, wherein
the protective portion covers an area of the inner surface of the recessed portion that is located at a level below the lid portion.

13. The breaker device according to claim 11, wherein
the protective portion is
a metal layer covering the inner surface of the recessed portion or
an insulating layer covering the inner surface of the recessed portion and made from a material different from a material of the pusher, and
the protective portion is located between the lid portion and the pusher.

14. The breaker device according to claim 11, wherein
the protective portion is a metal member or an insulating member disposed inside the recessed portion, and
the metal member or the insulating member is located between the lid portion and the pusher.

15. The breaker device according to claim 11, wherein
the protective portion completely covers the inner surface of the recessed portion that is located at a level below the lid portion.

16. The breaker device according to claim 11, wherein
the protective portion is configured to come into contact with the lid portion when the gas is generated.

17. The breaker device according to claim 1, wherein
when the pusher receives the pressure of the gas generated by the igniter, the pusher cuts off the separating portion from the conductor and moves the separating portion downward.
